(19) United States
(12) Patent Application Publication
(10) Pub. No.: US 2015/0210087 A1
(43) Pub. Date: Jul. 30, 2015

(54) INK JET RECORDING METHOD AND RECORDING APPARATUS

(71) Applicant: Seiko Epson Corporation, Tokyo (JP)

(72) Inventors: Hiroshi Fukumoto, Shiojiri-shi (JP); Hiroaki Kida, Shiojiri-shi (JP)

(73) Assignee: Seiko Epson Corporation, Tokyo (JP)

(21) Appl. No.: 14/609,754

(22) Filed: Jan. 30, 2015

(30) Foreign Application Priority Data
Jan. 30, 2014 (JP) 2014-015226

(51) Int. Cl. B41J 11/00

(52) U.S. Cl. CPC B41J 11/002

(57) ABSTRACT

An ink jet recording method for recording using an ink jet head having a nozzle forming surface and an irradiator having a light emitting portion for initially irradiating an ink composition attached to a recording medium with ultraviolet rays, in which a closest distance between an end portion of the nozzle forming surface and an end portion of the light emitting portion is equal to or less than 60 mm, the method including attaching to a recording medium by discharging an ink composition for ultraviolet ray curable-type ink jet recording including a tri- or higher functional polymerizable compound of equal to or less than 15% by mass and a photopolymerization Initiator, irradiating the ink composition for ultraviolet ray curable-type ink jet recording attached to the recording medium with ultraviolet rays from the light emitting portion, and cleaning the nozzle forming surface with a cleaning liquid by a wiping member.

### BACKGROUND

1. Technical Field

The present invention relates to an ink jet recording method and a recording apparatus.

2. Related Art

In the ink jet recording method, a high-resolution image can be recorded with a relatively simple apparatus, and rapid development has been achieved in various fields. Among these, in the ink jet recording method in which an ink composition is cured by irradiation with ultraviolet rays, various studies have been made for suppressing bleeding. For example, JP-A-2011-178142 discloses a printing method in which for the purpose of improving printing characteristic such as bleeding by devising an order of a series of discharge and curing for plural ink compositions, a first ink composition having a first coloring material, a first polymerizable compound, and a first photopolymerization initiator, and a second ink composition having a second coloring material, a second polymerizable compound, and a second photopolymerization initiator are discharged onto a recording medium, and by curing this discharged composition by irradiation with light, printing is performed, and which has a step in which photocurability of the first ink composition is higher than photocurability of the second ink composition, and after the first ink composition is discharged and is cured by irradiation with light, the second ink composition is discharged and is cured by irradiation with light.

However, in a case where an ink composition having high curability as in JP-A-2011-178142 is used, there is a problem in which it is difficult to restore discharge stability (hereinafter, also referred to as “cleaning return property”) by cleaning ink jet nozzles. Specifically, in a case where an ultraviolet ray irradiator is disposed near an ink jet head from the viewpoint of enhancing curability, light is leaked from the ultraviolet ray irradiator to the ink jet head, and a crosslinked polymer derived from the ink composition is generated at the ink jet nozzles. Such a crosslinked polymer not only reduces discharge stability but also becomes a factor which makes discharge stability difficult to be restored in a case of cleaning the ink jet nozzles.

In contrast, in a case where an ink composition having low curability is used, there is a problem that since only the surface is cured first without the inside being cured in a recorded matter, wrinkles are generated.

In addition, in a case where an ultraviolet ray irradiator is disposed near an ink jet head, there is also a problem that since a landed ink is cured before the landed ink wets and spreads, streaks (hereinafter, also referred to as “streak unevenness”) extending in the transport direction of the recording medium can be generated. In contrast, in a case where an ultraviolet ray irradiator is disposed away from an ink jet head, there is a problem that since it takes a long time to cure after landing, “bleeding” in which characters are blurred, and color spreads occurs.

### SUMMARY

An advantage of some aspects of the invention is to provide an ink jet recording method in which bleeding, streak unevenness, and wrinkles are less likely to occur, and a cleaning return property is excellent, and a recording apparatus for performing the ink jet recording method.

The present inventors have made thorough studies to solve the above problems. As a result, the inventors have found that the above problems can be solved by adjusting the positions of an ink jet head and an irradiator having a light emitting portion, using a predetermined ink composition, and further performing a predetermined cleaning step, thereby completing the invention.

That is, the invention is as follows.

[1] According to an aspect of the invention, there is provided an ink jet recording method for recording using a recording apparatus equipped with an ink jet head having a nozzle forming surface on which a nozzle is formed and an irradiator having a light emitting portion for initially irradiating an ink composition attached to a recording medium by discharging from the head with ultraviolet rays, in which a closest distance between an end portion of the nozzle forming surface and an end portion of the light emitting portion is equal to or less than 60 mm, the method including attaching to a recording medium by discharging an ink composition for ultraviolet ray curable-type ink jet recording including a tri- or higher functional polymerizable compound of equal to or less than 15% by mass and a photopolymerization initiator from the nozzle, irradiating the ink composition for ultraviolet ray curable-type ink jet recording attached to the recording medium with ultraviolet rays from the light emitting portion, and cleaning the nozzle forming surface with a cleaning liquid and a wiping member.

[2] In the method according to [1], the ink jet head may have a nozzle array width of a length equal to or greater than a recording width of the recording medium, the attaching may be performed by a single scan of the ink jet head relative to the recording medium.

[3] In the method according to [1] or [2], the cleaning liquid may include an alkylene glycol derivative.

[4] In the method according to any one of [1] to [3], the ink composition for ultraviolet ray curable-type ink jet recording may include a mono- or bifunctional polymerizable compound of 50% by mass to 90% by mass.

[5] In the method according to any one of [1] to [4], the irradiator may be equipped with a light source, and the light source may be a semiconductor light source having a peak wavelength in a wavelength range of 350 nm to 420 nm.

[6] In the method according to any one of [1] to [5], the photopolymerization initiator may include an acyl phosphine oxide-based photopolymerization initiator of 5% by mass to 15% by mass with respect to the total amount of the ink composition for ultraviolet ray curable-type ink jet recording.

[7] The method according to any one of [1] to [6], further including a post-irradiation of irradiating the ink composition for ultraviolet ray curable-type ink jet recording gone through the irradiation with ultraviolet rays one or two or more times which is performed after the irradiation.

[8] In the method according to [7], ultraviolet ray irradiation energy in the irradiation may be a 1/150 to 1/7 of the total amount of ultraviolet ray irradiation energy in the post-irradiation.

[9] In the method according to [7] or [8], the total amount of ultraviolet ray irradiation energy in the irradiation and the post-irradiation may be 100 mJ/cm² to 1500 mJ/cm², and ultraviolet ray irradiation energy in the irradiation may be 5 mJ/cm² to 40 mJ/cm².

[10] According to another aspect of the invention, there is provided a recording apparatus, in which the ink jet recording method according to any one of [1] to [9] is performed.

### BRIEF DESCRIPTION OF THE DRAWINGS

The invention will be described with reference to the accompanying drawings, wherein like numbers reference like elements.

FIG. 1 is a block diagram showing an example of a configuration of a recording apparatus capable of being used in the embodiment.

FIG. 2 is a cross-sectional diagram for showing an example around a head unit, a transport unit, and an irradiation unit in a line printer which is an example of the recording apparatus capable of being used in the embodiment.

FIG. 3 is a schematic view illustrating a distance between an end portion of a nozzle forming surface closest to a light emitting portion and an end portion of the light emitting portion closest to the nozzle forming surface.

FIG. 4 is a schematic view illustrating the light emitting portion.

FIG. 5 is a schematic diagram showing an example of a mechanism used in cleaning of an ink jet recording method according to the embodiment.

### DESCRIPTION OF EXEMPLARY EMBODIMENTS

Hereinafter, an embodiment for carrying out the invention (hereinafter, referred to as “the embodiment”) will be described in detail with reference to the drawings as necessary. Furthermore, the invention is not limited thereto, and various modifications are possible without departing from the gist of the invention. Moreover, in the drawings, the same reference numerals are given to the same element, and the overlapping descriptions will not be repeated. In addition, a positional relationship such as upward, downward, leftward and rightward is based on the positional relationship shown in the drawings unless stated otherwise. Moreover, the dimensional ratio of the drawings is not limited to the ratio shown.

### Recording Apparatus

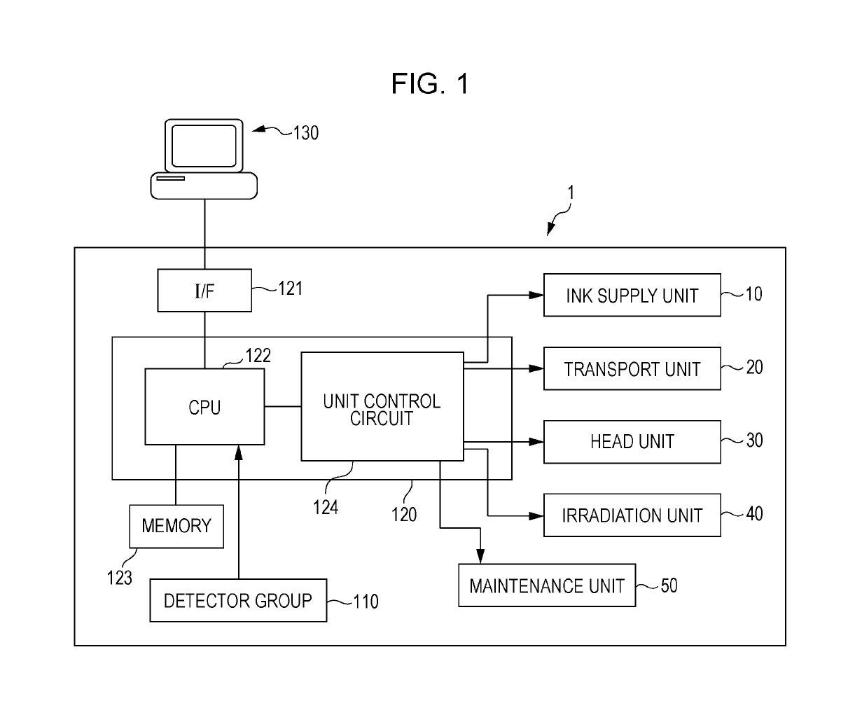

The recording apparatus of the embodiment is a recording apparatus used in the ink jet recording method described below. The configuration of the recording apparatus is not particularly limited, and may be that described with reference to FIGS. 1 to 5.

In FIG. 1, a block diagram showing an example of a configuration of a recording apparatus capable of being used in the embodiment is shown. A printer driver is installed to a computer 130, and print data corresponding to an image is output to a printer 1 such that the printer 1 records the image. The printer 1 corresponds to “recording apparatus” of the invention. The printer 1 has an ink supply unit 10, a transport unit 20, a head unit 30, an irradiation unit 40, a maintenance unit 50, a detector group 110, a memory 123, an interface 121, and a controller 120. The controller 120 has a CPU 122 and a unit control circuit 124. The printer 1 which receives printing data from the computer 130 which is an external apparatus controls each unit by the controller 120 and records an image on a recording medium according to the printing data. The situation in the printer 1 is monitored by the detector group 110, and the detector group 110 outputs the detection result to the controller 120. The controller 120 controls each unit on the basis of the detection result output from the detector group 110, and stores the printing data input through the interface 121 at the memory 123. In the memory 123, control information for controlling each unit is also stored.

### Ink Jet Head

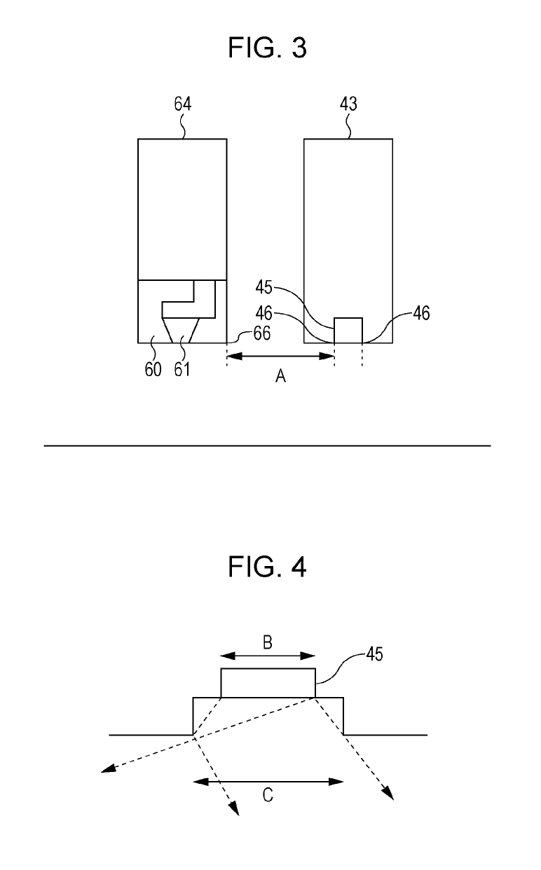

The head unit 30 which the recording apparatus (printer 1) has is equipped with a head (ink jet head) for recording by discharging an ink composition toward a recording medium. The head has cavities for discharging an accommodated ink composition from nozzles, a discharge driving portion for applying a driving force for discharging an ink provided for each cavity, nozzles for discharging an ink composition to the outside of the head provided for each cavity, and a nozzle forming surface on which nozzles are formed. Plural cavities, the discharge driving portion and the nozzles provided for each cavity may be provided at one head independently of each other. The discharge driving portion can be formed by using an electromechanical conversion element such as a piezoelectric element for changing a volume of a cavity by mechanical deformation or an electronic thermal conversion element for generating bubbles in the ink by generating heat and discharging the bubbles. In the recording apparatus, one head may be provided with respect to an ink of one color, or plural heads may be provided for an ink of one color, and in a case where plural heads are provided, a line head may be configured by arranging the plural heads in the width direction of the recording medium, and in this case, it is possible to make the recording width described above longer. In a case where recording is performed using ink compositions of plural colors, the recording apparatus is equipped with a head for each ink. The head can be configured, for example, as in FIG. 3 or the like in JP-A-2009-279830.

In a case where the recording apparatus is a line printer which is a recording apparatus of a line type, a line head which has a length equal to or longer than a length corresponding to the width of a recording medium as a head is equipped. While relatively changing a position in the scanning direction in which the line head and the recording medium intersect with the width direction, the ink composition is discharged from the line head toward the recording medium. In the line printer, a head is fixed so as almost not to be moved, and recording is performed in one pass (single pass). The line printer is advantageous over a serial printer from the viewpoint of fast recording speed.

Here, “the ink jet head having a nozzle array width of a length equal to or greater than a recording width of a recording medium” described above is not limited to a case where the width of a recording medium and the length (width) of a line head completely match, and the width of a recording medium and the length (width) of a line head may be different from each other. As such a case, for example, a case where the length (width) of a line head is a length corresponding to a width (recording width) of a recording medium on which an ink composition is discharged (an image is recorded) can be exemplified.

On the other hand, in a serial printer which is a serial type recording apparatus, while a head moves in the main scanning direction intersecting with the sub-scanning direction of a recording medium, a main scanning (pass) which performs discharge of an ink composition is performed, and usually, recording is performed in two or more passes (multipass).

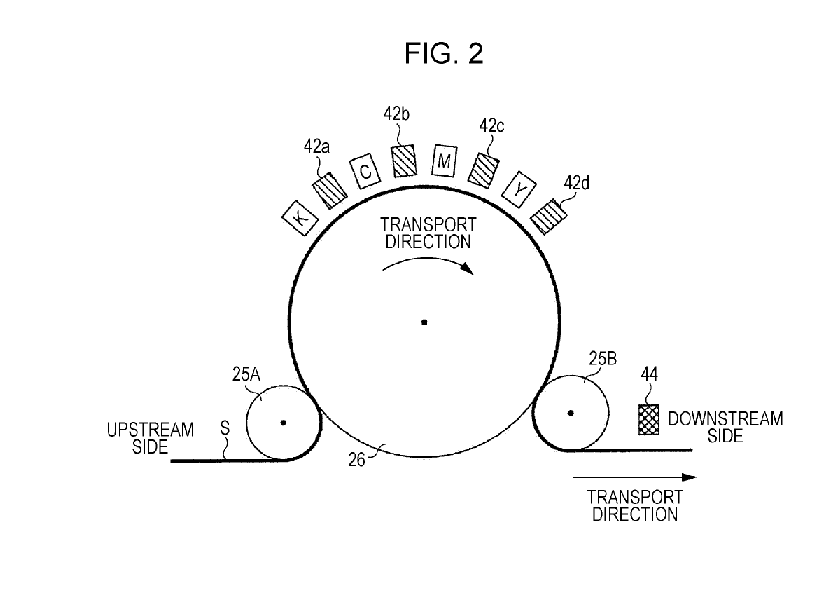

Hereinafter, the line printer which is an example of the recording apparatus capable of being used in the embodiment will be described with reference to FIG. 2. In FIG. 2 used for the description below, the scale of each member is suitably changed since each member is required to be big enough to be recognizable.

FIG. 2 is a cross-sectional diagram for showing an example around a head unit, a transport unit, and an irradiation unit in a line printer described above which is an example of a printer capable of being used in the embodiment.

By a transport motor (not shown), a transport roller configured of an upstream side roller 25A and a downstream side roller 25B is rotated, and a transport drum 26 is driven. The recording medium S is transported by the rotation of the transport roller along the peripheral surfaces of the transport rollers 25A and 25B and the transport drum 26 which is a support. Around the transport drum 26, respective line heads configured of a head K, a head C, a head M, and a head Y are disposed so as to face the peripheral surface of the transport drum 26. For example, the head K is for a black ink, the head C is for a cyan ink, the head M is for a magenta ink, and the head Y is for a yellow ink.

The transport drum 26 has a surface which transports the recording medium S on the peripheral surface, supports the recording medium S on the surface, and relatively moves with respect to the head. In a case where the transport drum 26 relatively moves with respect to the head while supporting the recording medium S, a time (period) until the transport drum 26 returns from an arbitrary position to the same position is preferably at least equal to or longer than 5 seconds, and more preferably equal to or longer than 6 seconds. When the time is within the above range, the time for heat radiation of the support is secured, and there is a tendency that temperature rise can be suppressed. In addition, although the upper limit of the above period is not particularly limited, in order to realize high-speed printing, for example, the upper limit is preferably within 15 seconds.

Moreover, the movement in a predetermined period by the support may be made while at least the ink jet recording is performed, and furthermore, the movement may be continuously or intermittently made while the ink jet recording is performed.

The shape of the support is not limited to a drum shape as the support in FIG. 2, and the shape is not particularly limited, for example, a roller shape support, a belt shape support, and a plate shape support (platen or the like) for supporting the recording medium S can be exemplified. Movement of the support relative to a head may be movement in which the support returns to the same position by moving (rotating) in one direction, or may be movement in which the support returns to the same position by combination of movement in any one direction and movement in the other direction. In the latter case, a form in which a movement in any one direction is a movement according to recording on one recording medium of a cut sheet type, and a movement in the other direction is a movement for performing recording on a next recording medium after finishing recording on one recording medium can be exemplified.

Moreover, in a case of a serial printer, movement in the any one direction corresponds to a sub-scanning. In addition, movement of the support relative to a head may be relative movement of the support with respect to a head, and also includes movement in which the head moves with respect to the support.

The material of the support is not particularly limited, and for example, a metal, a resin, and rubber can be exemplified. Among these, a metal is preferable. When the material is a metal, unlike a case of a polymeric material such as rubber, even if the support is used for a long period of time, cracks which are considered to be from degradation due to heat do not occur, and long-term use becomes possible. The metal is not particularly limited, and for example, aluminum, stainless steel, copper, iron, and alloys of these can be exemplified. Furthermore, the surface of the metal support, that is, the transport surface of the recording medium S may be coated with a coating agent or the like. Thereby, it is possible to improve hardness of the support surface, and it is possible to make the support not slippery against the recording medium, compared to the support which is not coated with a coating agent. The coating agent is not particularly limited, and for example, organic coating agents such as a resin, inorganic coating agents such as an inorganic compound, and composite coating agents of these can be exemplified. Moreover, matters regarding the support described above are not limited to the line printer, and can also be applied to the serial printer.

In this manner, recording is performed by a discharge operation of discharging an ink composition towards the recording medium S opposite to the respective line heads and attaching the ink composition.

### Irradiator

The irradiator has a light emitting portion. The irradiator is equipped with a light source, and the light source, which is not particularly limited, includes semiconductor light sources such as an LED (light emitting diode) including an ultraviolet ray emitting diode (UV-LED) and an ultraviolet ray laser diode (UV-LD), a metal halide light source, or a mercury lamp. Among these, a semiconductor light source having a peak wavelength in a wavelength range of 350 nm to 420 nm is preferable, and an LED having a peak wavelength in a wavelength range of 350 nm to 420 nm is more preferable. By using a semiconductor light source, miniaturization and a long life of the recording apparatus, and a high efficiency and reduction of cost of the ink jet recording method are possible compared to a case of using a metal halide light source or a mercury lamp. In addition, when a peak wavelength is within the above range, there is a benefit that curability tends to be improved by combination with the initiator used in the embodiment, or the light source can be manufactured at a low cost compared to the LED of which the peak wavelength is at a lower wavelength.

“The light emitting portion” refers to the whole portions (portions at which emitting of light is visible) in which light, including not only light from a light source element itself emitting light but also reflected light and scattered light from the light source element, is emitted from an irradiator to the outside of the irradiator. In addition, in a case where the light emitting portion has a lens or a cover on the light emitting surface and emission of light from the lens or the cover is visible, the lens or the cover is also an emitting portion. In addition, as shown in FIG. 3, in a case where a light emitting element is installed in the recess, the length of the element itself is B, however, the length of the light emitting portion in which light is actually emitted is a length C which also includes the reflected light.

“An end portion of the light emitting portion closest to a nozzle forming surface” refers to an end portion closest to the nozzle forming surface among end portions of the emitting portion of light described above.

The distance between the end portion of the nozzle forming surface closest to the light emitting portion and the end portion of the light emitting portion closest to the nozzle forming surface is equal to or less than 60 mm, and preferably equal to or less than 50 mm. When the distance between the end portion of the nozzle forming surface closest to the light emitting portion and the end portion of the light emitting portion closest to the nozzle forming surface is equal to or less than 60 mm, bleeding and wrinkles are further improved. Moreover, “the distance between the end portion of the nozzle forming surface closest to the light emitting portion and the end portion of the light emitting portion closest to the nozzle forming surface” is a straight line distance between the end portion of the nozzle forming surface closest to the light emitting portion and the end portion of the light emitting portion closest to the nozzle forming surface.

In addition, the distance between the end portion of the nozzle forming surface closest to the light emitting portion and the end portion of the light emitting portion closest to the nozzle forming surface is preferably equal to or greater than 20 mm, and more preferably equal to or greater than 30 mm. When the distance between the end portion of the nozzle forming surface closest to the light emitting portion and the end portion of the light emitting portion closest to the nozzle forming surface is equal to or greater than 20 mm, streak unevenness, and a cleaning return property tend to be further improved.

In FIG. 3, a schematic view illustrating the closest distance between the end portion of the nozzle forming surface and the end portion of the light emitting portion is shown. As shown in FIG. 3, in the recording apparatus used in the ink jet recording method of the embodiment, for example, in a case where an irradiator for initially irradiating an ink composition attached to a recording medium by discharging from a nozzle 61 of a head 64 on the left side in FIG. 3 with light is an irradiator 43, the distance A between an end portion 66 on a nozzle forming surface 60 of the head 64 and an end portion 46 of a light emitting portion 45 of the irradiator 43 is equal to or less than 60 mm. In a case where the end portion 66 on the nozzle forming surface 60 or the end portion 46 of the light emitting portion 45 has a predetermined length and the above distance can take plural distances, the above distance is a distance closest (shortest) among the distances between the end portion 66 and the end portion 46. In addition, the closest distance is not limited to the distance on the surface parallel to the recording medium transport surface of FIG. 3, and is a closest distance in a three-dimensions when also considering the direction perpendicular to the transport surface. In a case of the above closest distance, the end portion on the nozzle forming surface is the end portion on the nozzle forming surface closest to the light emitting portion, and the end portion of the light emitting portion is the end portion of the light emitting portion closest to the nozzle forming surface.

In a case where there are plural ink jet heads 64, at least one ink jet head 64 may have the distance A between the head 64 and the irradiator 43 in the above relationship of equal to or less than 60 mm. In the ink jet head 64, effects of the embodiment can be exhibited.

The distance between the nozzle forming surface and a recording medium is preferably 0.5 mm to 10 mm, and more preferably 0.5 mm to 5 mm. When the distance between the nozzle forming surface and a recording medium is within the above range, it is possible to reduce light leakage, and a cleaning return property tends to be further improved.

The distance from the end portion of the nozzle forming surface closest to the light emitting portion to a nozzle closest to the end portion is preferably 0.5 cm to 5 cm, and more preferably 0.5 cm to 3 cm. When the distance from the end portion of the nozzle forming surface closest to the light emitting portion to a nozzle closest to the end portion is within the above range, by ensuring a sufficient area, it is possible to ensure a wiping property, and by not increasing more than necessary, it is possible to make the apparatus compact.

The nozzle is preferably formed on substantially the center in the transport direction on the nozzle forming surface. Thereby, by not biasedly disposing, there is a tendency that it is possible to secure a wiping property everyplace.

As shown in FIG. 2, temporary curing irradiation portions 42a, 42b, 42c, and 42d are disposed on the downstream side in the transport direction of each line head. In an irradiation step using the recording apparatus, the temporary curing irradiation portions 42a irradiate the recording medium S with ultraviolet rays. In addition, a main curing irradiation portion 44 is disposed on the further downstream side in the transport direction, and in a post-irradiation step, the temporary curing irradiation portions 42b, 42c, and 42d, and the main curing irradiation portion 44 irradiates the recording medium S with ultraviolet rays. For example, such a recording apparatus can be configured as in FIG. 11 in JP-A-2010-269471.

More specifically, in the case where an ink composition is discharged using the head K, the irradiation step can be performed by the temporary curing irradiation portion 42a, and the post-irradiation step can be performed by the temporary curing irradiation portions 42b, 42c, and 42d, and the main curing irradiation portion 44. In addition, in the case where an ink composition is discharged using the head C, the irradiation step can be performed by the temporary curing irradiation portion 42b, and the post-irradiation step can be performed by the temporary curing irradiation portions 42c and 42d, and the main curing irradiation portion 44. Furthermore, in the case where an ink composition is discharged using the head M, the irradiation step can be performed by the temporary curing irradiation portion 42c, and the post-irradiation step can be performed by the temporary curing irradiation portions 42d and the main curing irradiation portion 44. In addition, in the case where an ink composition is discharged using the head Y, the irradiation step can be performed by the temporary curing irradiation portion 42d, and the post-irradiation step can be performed by the main curing irradiation portion 44.

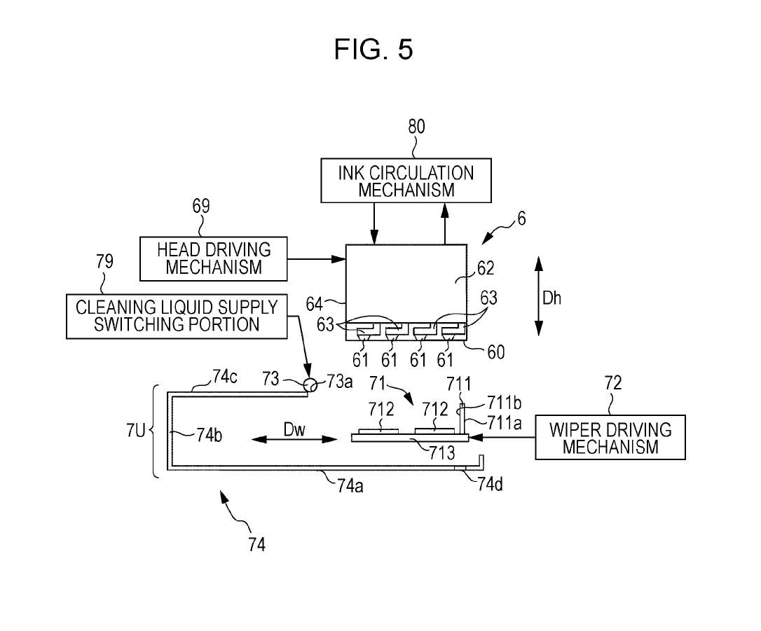

In FIG. 5, a schematic diagram showing an example of a mechanism performing cleaning in a cleaning step is shown. Hereinafter, although cleaning performed with respect to one head is described, in a case where there are plural heads, each head may be cleaned in the same manner. In addition, for convenience of description, although a case where the nozzle forming surface 60 is substantially horizontal as shown in FIG. 5 is described, the nozzle forming surface may not be substantially horizontal.

A maintenance unit 7U used in the cleaning step is arranged with one for each head 64, and maintenance such as wiping (cleaning) or capping is performed with respect to the head 64. The maintenance unit 7U may be provided in the vicinity of a platen (drum 26 in the recording apparatus) of the head 64. For example, in FIG. 2, the maintenance unit 7U may be provided in the depth direction of the drum 26. On the other hand, the head 64 is configured to freely move between a printing position above the platen and a maintenance position above the maintenance unit 7U in the depth direction (Y direction) in the figure by a head drive mechanism 69. Furthermore, the head 64 is configured to freely move in the forward and backward direction Dh orthogonal to the nozzle forming surface 60 by the head drive mechanism 69 such that a cleaning position close to the maintenance unit 7U or a retracted position separated from the maintenance unit 7U in the maintenance position can be taken. Furthermore, at the time of maintenance, the head 64 is suitably moved in the forward and backward direction Dh according to a maintenance process.

The head 64 has the nozzle 61 which is open on the nozzle forming surface 60, a reservoir 62 for temporarily storing an ink composition, and a cavity 63 communicating the nozzle 61 and the reservoir 62, and an ink composition is supplied to the nozzle 61 through the cavity 63 from the reservoir 62. Furthermore, the cavity 63 applies pressure to an ink composition according to an operation command from the controller 120 (FIG. 1), and thereby an ink composition is discharged from the nozzle 61. Although four nozzles 61 are horizontally disposed for description in FIG. 5, the number of nozzles is not limited thereto, and the position of disposition also is not limited thereto. An ink circulation mechanism 80 is provided with respect to the head 64, and by the ink circulation mechanism 80, speed or pressure of an ink composition which circulates between a tank (not shown) for storing the ink composition and the reservoir 62 of the head 64 is adjusted.

The maintenance unit 7U is configured to include a movable body 71 having a wiper 711 which is a flexible wiping member, a cap 712, and a supporting member 713 for supporting these in an integrally movable manner, a wiper driving mechanism 72 for moving the movable body 71 in the wiping direction Dw along the nozzle forming surface 60, a cleaning liquid supply pipe 73 for ejecting a cleaning liquid from an ejecting port 73a, and a housing 74. The length in the Y direction of each of these members is equal to or greater than that of the head 64, and it is possible to perform cleaning the entire region of the nozzle forming surface 60. Furthermore, the wiper 711 moves in the wiping direction Dw in a state of wiping surfaces 711a and 711b in contact with the nozzle forming surface 60, and thereby, wiping is performed, and the nozzle forming surface 60 is cleaned. In addition, the cap 712 is brought into close contact with the nozzle forming surface 60 so as to cover all the nozzles 61, and thereby, capping is performed.

The cleaning liquid supply pipe 73 has a plurality of the ejecting ports 73a which is open towards the side of the head 64 in the Y direction, and is configured to be capable of ejecting a cleaning liquid with respect to at least one of the nozzle forming surface 60 of the head 64 and the wiper 711. Here, as the cleaning liquid supplied for wiping, those described above can be exemplified. Switching of the supply of a cleaning liquid by the cleaning liquid supply pipe 73 is performed by the cleaning liquid supply switching portion 79.

The housing 74 is configured to have, mainly, a bottom surface portion 74a substantially parallel with the wiping direction Dw, a side wall portion 74b which is perpendicularly provided from one end in the wiping direction Dw of the bottom surface portion 74a, and an eave portion 74c extending on the same side as the bottom surface portion 74a along the wiping direction Dw from the upper end of the side wall portion 74b. The bottom surface portion 74a is provided over a slightly wider range than a movable range of the movable body 71 in the wiping direction Dw, and receives waste fluid including an ink, a cleaning liquid, or the like generated at the time of cleaning. Waste liquid received by the bottom surface portion 74a is discharged from the maintenance unit 7U through an outlet 74d formed in the bottom surface portion 74a. The size of the eave portion 74c in the wiping direction Dw is larger than that of the movable body 71. Furthermore, at the time of a printing operation, the movable body 71 remains in a state covered with the eave portion 74c at a standby position below the eave portion 74c. By doing so, the eave portion 74c blocks light (ultraviolet rays) emitted from a UV lamp, and as a result, it is possible to prevent the UV ink attached to the wiper 711 or the cap 712 from being cured.

### Ink Jet Recording Method

The ink jet recording method of the embodiment for recording using a recording apparatus equipped with an ink jet head having a nozzle forming surface on which a nozzle is formed and an irradiator having a light emitting portion for initially irradiating an ink composition attached to a recording medium by discharging from the head, in which a distance between an end portion of the nozzle forming surface closest to the light emitting portion and an end portion of the light emitting portion closest to the nozzle forming surface is equal to or less than 60 mm has an attaching step of attaching to a recording medium by discharging an ink composition (hereinafter, simply referred to as “ink composition”) for ultraviolet ray curable-type ink jet recording including a tri- or higher functional polymerizable compound of equal to or less than 15% by mass and a photopolymerization initiator from the nozzle, an irradiation step of irradiating the ink composition for ultraviolet ray curable-type ink jet recording attached to the recording medium with ultraviolet rays from the light emitting portion, and a cleaning step of cleaning the nozzle forming surface with a cleaning liquid and a wiping member.

In the ink jet recording method of curing an ink composition by irradiation with ultraviolet rays, it is preferable to quickly cure the ink composition after being attached to a recording medium by making the distance between the ink jet head and the irradiator short from the viewpoint of suppressing bleeding. In addition, it is preferable to use a tri- or higher functional polymerizable compound from the viewpoint of curability of an ink composition, wrinkle suppression of a cured coating film, and abrasion resistance of a recorded material. However, when the distance between the ink jet head and the irradiator is made to be short, and a tri- or higher functional polymerizable compound is used, leakage light (including reflected light by a recording medium) from the irradiator is irradiated to the nozzle forming surface, and contamination due to a polymer of the a tri- or higher functional polymerizable compound on the nozzle forming surface is generated, and due to this, a flying bend or a non-discharge occurs. Such a polymer is difficult to be removed by flushing, suction, discharge of ink by applying pressure, or cleaning by rubbing the nozzle surface with a wiping member, and thus, there is a problem that a cleaning return property may be reduced.

Therefore, in the ink jet recording method of the embodiment, the distance between the ink jet head and the irradiator is made to be short, and a tri- or higher functional polymerizable compound is used, and thereby, it is possible to obtain a recorded material in which bleeding, streak unevenness, and wrinkles are suppressed, and by using a predetermined amount of a tri- or higher functional polymerizable compound and through a predetermined cleaning step, a cleaning return property is improved.

### Attaching Step

The attaching step is a step of discharging the ink composition from a nozzle and attaching the discharged ink composition on a recording medium. The recording apparatus used in the ink jet recording method of the embodiment is equipped with an ink jet head having a nozzle forming surface on which a nozzle is formed and an irradiator having a light emitting portion for initially irradiating ultraviolet rays to an ink composition attached to a recording medium by discharging from the head, and in the recording apparatus, a closest distance between the end portion of the nozzle forming surface and the end portion of the light emitting portion is equal to or less than 60 mm.

In the attaching step, the ink jet head having a nozzle array width of a length equal to or greater than a recording width of a recording medium is preferably scanned only once relatively with respect to the recording medium. That is, the ink jet recording method of the embodiment is preferably performed by using a line printer which performs recording by one pass printing. In general, bleeding tends to more easily occur in a line printer (one pass printing) in which all dots are attached in one pass and irradiated with ultraviolet rays than a serial printer in which dots of an adjacent pixel is attached in a separate pass and irradiation with ultraviolet rays is performed in every passes. For this reason, in the ink jet recording method performed by using the line printer, the invention is particularly useful.

### Ink Composition for Ultraviolet Ray Curable-Type Ink Jet Recording

The ink composition for ultraviolet ray curable-type ink jet recording used in the ink jet recording method of the embodiment includes a tri- or higher functional polymerizable compound of equal to or less than 15% by mass and a photopolymerization initiator.

### Tri- or Higher Functional Polymerizable Compound

Using a tri- or higher functional polymerizable compound, curability and a bleed resistance are improved, tackiness is reduced, and an occurrence of wrinkles is further suppressed. On the other hand, although there is a concern that recovery of discharge abnormality may become difficult in order to further increase a crosslinking property, if the embodiment having the cleaning step is used, the advantage of a polymerizable compound having a tri- or higher functional polymerizable compound can be taken while recovering the discharge abnormality due to an excellent cleaning return property.

Examples of the tri- or higher functional polymerizable compound, which are not particularly limited, include trimethylolpropane tri(meth)acrylate, EO-modified trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerinpropoxytri(meth)acrylate, caprolactone-modified trimethylolpropane tri(meth)acrylate, pentaerythritol ethoxytetra(meth)acrylate, and caprolactam-modified dipentaerythritol hexa(meth)acrylate.

The content of the tri- or higher functional polymerizable compound is equal to or less than 15% by mass, and preferably equal to or less than 10% by mass with respect to the total amount of the ink composition for ultraviolet ray curable-type ink jet recording. When the content of the tri- or higher functional polymerizable compound is equal to or less than 15% by mass, a cleaning return property is further improved. In addition, the lower limit of the content of the tri- or higher functional polymerizable compound is preferably equal to or greater than 1% by mass, and more preferably equal to or greater than 3% by mass with respect to the total amount of the ink composition for ultraviolet ray curable-type ink jet recording. When the content of the tri- or higher functional polymerizable compound is equal to or greater than 1% by mass, there is a tendency that curability and a bleed resistance are improved, tackiness is reduced, and an occurrence of wrinkles is further suppressed. Among the tri- or higher functional polymerizable compounds, a tetra- or higher functional polymerizable compound is preferable, a penta- or higher functional polymerizable compound is more preferable, a hexa- or higher functional polymerizable compound is still more preferable, and a deca- or higher functional polymerizable compound is preferable. A case of these is more preferable from the viewpoint of the above tendency. As the polymerizable compound, a tri- or higher functional polymerizable compound as the number of a (meth)acrylate group is more preferable from the viewpoint of the above tendency.

### Mono- or Bifunctional Polymerizable Compound

The ink composition may include a mono- or bifunctional polymerizable compound having a polymerizable functional group such as a vinyl ether group, a vinyl group, or (meth)acrylate group. Examples of the polymerizable compound, which are not particularly limited, include isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol (meth)acrylate, 2-hydroxybutyl (meth)acrylate, butoxyethyl (meth)acrylate, ethoxydiethylene glycol (meth)acrylate, methoxydiethylene glycol (meth)acrylate, methoxypolyethylene glycol (meth)acrylate, methoxypropylene glycol (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxypropyl (meth)acrylate, lactone-modified flexible (meth)acrylate, t-butyl cyclohexyl (meth)acrylate, dicyclopentanyl (meth)acrylate, dicyclopentenyloxyethyl (meth)acrylate, 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 1-methyl-3-vinyloxypropyl (meth)acrylate, 1-vinyloxymethylpropyl (meth)acrylate, 2-methyl-3-vinyloxypropyl (meth)acrylate, 1,1-dimethyl-2-vinyloxyethyl (meth)acrylate, 3-vinyloxybutyl (meth)acrylate, 1-methyl-2-vinyloxypropyl (meth)acrylate, 2-vinyloxybutyl (meth)acrylate, 4-vinyloxycyclohexyl (meth)acrylate, 6-vinyloxyhexyl (meth)acrylate, 4-vinyloxymethylcyclohexylmethyl (meth)acrylate, 3-vinyloxymethylcyclohexylmethyl (meth)acrylate, 2-vinyloxymethylcyclohexylmethyl (meth)acrylate, p-vinyloxymethylphenylmethyl (meth)acrylate, m-vinyloxymethylphenylmethyl (meth)acrylate, o-vinyloxymethylphenylmethyl (meth)acrylate, 2-(vinyloxyethoxy)ethyl (meth)acrylate, 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, polypropylene glycol monovinyl ether (meth)acrylate, phenoxyethyl (meth)acrylate, isobornyl (meth)acrylate, benzyl (meth)acrylate, triethylene glycol di(meth)acrylate, tetraethylene glycol di(meth)acrylate, polyethylene glycol di(meth)acrylate, dipropylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, EO (ethylene oxide) adduct di(meth)acrylate of bisphenol A, PO (propylene oxide) adduct di(meth)acrylate of bisphenol A, hydroxypivalic acid neopentyl glycol di(meth)acrylate, polytetramethylene glycol di(meth)acrylate, diethylene glycol di(meth)acrylate, triethylene glycol di(meth)acrylate, and mono- or bifunctional (meth)acrylate having a pentaerythritol skeleton or a dipentaerythritol skeleton.

The content of the mono- or bifunctional polymerizable compound is preferably equal to or less than 90% by mass, and more preferably equal to or less than 85% by mass with respect to the total amount of the ink composition. When the content of the mono- or bifunctional polymerizable compound is equal to or less than 90% by mass, there is a tendency that curability and a bleed resistance are improved, tackiness is reduced, and an occurrence of wrinkles is further suppressed. In addition, the lower limit of the content of the mono- or bifunctional polymerizable compound is preferably equal to or greater than 40% by mass, more preferably equal to or greater than 50% by mass, still more preferably equal to or greater than 60% by mass with respect to the total amount of the ink composition. When the content of the mono- or bifunctional polymerizable compound is equal to or less than 40% by mass, there is a tendency that a cleaning return property is further improved, and reduction in viscosity of an ink, solubility of an initiator, or the like is excellent. In addition, among the mono- or bifunctional polymerizable compounds, a polymerizable compound having at least one (meth)acrylate group is preferable, and as the polymerizable compound, at least any one of monofunctional (meth)acrylate, bifunctional (meth)acrylate, and a polymerizable compound having one (meth)acrylate group and one vinyl ether group can be exemplified. A case of including these is preferable from the viewpoint of the above tendency.

### Photopolymerization Initiator

The photopolymerization initiator included in the ink composition is not limited as long as it produces active species such as a radical or a cation and initiates a polymerization of the polymerizable compound by energy of light such as ultraviolet rays, and a radical polymerization initiator or a cationic polymerization initiator can be used, and between these, the radical polymerization initiator is preferably used.

Examples of a photo-radical polymerization initiator, which are not particularly limited, include an acylphosphine oxide-based polymerization initiator, a thioxanthone-based polymerization initiator, aromatic ketones, an aromatic onium salt compound, an organic peroxide, a thio compound (thiophenyl group-containing compound or the like), an α-aminoalkyl phenone compound, a hexaaryl biimidazole compound, a ketoxime ester compound, a borate compound, an azinium compound, a metallocene compound, an active ester compound, a compound having a carbon-halogen bond, and an alkyl amine compound.

Specific examples of the acylphosphine oxide-based photopolymerization initiator, which are not particularly limited, include bis(2,4,6-trimethylbenzoyl)-phenyl phosphine oxide, 2,4,6-trimethylbenzoyl-diphenyl-phosphine oxide, and bis-(2,6-dimethoxybenzoyl)-2,4,4-trimethylpentylphosphine oxide. Although such an acylphosphine oxide-based photopolymerization initiator is likely to be affected by oxygen inhibition, the acylphosphine oxide-based photopolymerization initiator is suitable for curing in a case of using an LED of long wavelength light.

Examples of commercially available products of the acylphosphine oxide-based photopolymerization initiator, which are not particularly limited, include Iragcure 819 (bis(2,4,6-trimethylbenzoyl)-phenyl phosphine oxide) and Darocur TPO (2,4,6-trimethylbenzoyl-diphenyl-phosphine oxide).

Specific examples of the thioxanthone-based photopolymerization initiator, which are not particularly limited, preferably include one or more types selected from the group consisting of thioxanthone, diethyl thioxanthone, isopropyl thioxanthone, and chlorothioxantone. Moreover, as the diethyl thioxanthone, 2,4-diethyl thioxanthone is preferable, as the isopropyl thioxanthone, 2-isopropyl thioxanthone is preferable, and as the chlorothioxantone, 2-chlorothioxantone is preferable, however they are not particularly limited. When an ink composition including such a thioxanthone-based photopolymerization initiator is used, it is possible to reduce surface tackiness, and in particular, it is possible to prevent color mixing among dots and bleeding by curing the ink surface at the time of forming a thin film which is likely to be affected by oxygen inhibition, and there is a tendency that curability, storage stability, and discharging stability become excellent. Among these, the thioxanthone-based photopolymerization initiator including diethyl thioxanthone is preferable. By including diethyl thioxanthone, there is a tendency that ultraviolet light (UV light) of a wide range can be converted to active species in a more efficient manner. In addition, by combining the acylphosphine oxide-based photopolymerization initiator and the thioxanthone-based photopolymerization initiator, there is a tendency that a curing process by UV-LED becomes excellent, and curability and adhesiveness of the ink composition is further improved.

Specific examples of commercially available products of the thioxanthone-based photopolymerization initiator, which are not particularly limited, include Speedcure DETX (2,4-diethylthioxanthone), Speedcure ITX (2-Isopropylthioxanthone) (hereinbefore, manufactured by Lambson, Ltd.), and KAYACURE DETX-S (2,4-diethylthioxanthone) (manufactured by Nippon Kayaku Co., Ltd.).

Examples of other photo-radical polymerization initiators, which are not particularly limited, include acetophenone, acetophenone benzyl ketal, 1-hydroxycyclohexyl phenyl ketone, 2,2-dimethoxy-2-phenyl acetophenone, xanthone, fluorenone, benzaldehyde, fluorene, anthraquinone, triphenylamine, carbazole, 3-methyl acetophenone, 4-chlorobenzophenone, 4,4′-dimethoxybenzophenone, 4,4′-diaminobenzophenone, Michler's ketone, benzoin propyl ether, benzoin ethyl ether, benzyldimethyl ketal, 1-(4-isopropylphenyl)-2-hydroxy-2-methylpropan-1-one, 2-hydroxy-2-methyl-1-phenylpropan-1-one, and 2-methyl-1-[4-(methylthio)phenyl]-2-morpholinopropan-1-one.

Examples of commercially available products of the photo-radical polymerization initiator, which are not particularly limited, include Irgacure 651 (2,2-dimethoxy-1,2-diphenylethan-1-one), Irgacure 184 (1-hydroxy-cyclohexyl-phenyl-ketone), DAROCUR 1173 (2-hydroxy-2-methyl-1-phenyl-propan-1-one), Irgacure 2959 (1-[4-(2-hydroxyethoxy)-phenyl]-2-hydroxy-2-methyl-1-propan-1-one), Irgacure 127 (2-hydroxy-1-4-[4-(2-hydroxy-2-methyl-propionyl)-benzyl]phenyl-2-methyl-propan-1-one}, Irgacure 907 (2-methyl-1-(4-methylthiophenyl)-2-morpholinopropan-1-one), Irgacure 369 (2-benzyl-2-dimethylamino-1-(4-morpholinophenyl)-butanone-1), Irgacure 379 (2-(dimethylamino)-2-[(4-methylphenyl)methyl]-1-[4-(4-morpholinyl)phenyl]-1-butanone), Irgacure 784 (Bis(eta5-2,4-cylcopentadien-1-yl)-bis(2,6-difluoro-3-(1H-pyrrol-1-yl)-phenyl) titanium), Irgacure OXE 01 (1,2-octanedione 1-[4-(phenylthio)-2-(O-benzoyl oxime)]), Irgacure OXE 02 (ethanone, 1-[9-ethyl-6-(2-methylbenzoyl)-9H-carbazol-3-yl]-1-(O-acetyl oxime)), Irgacure 754 (a mixture of oxyphenyl acetic acid 2-[2-oxo-2-phenylacetoxyethoxy]ethyl ester and oxyphenyl acetic acid 2-(2-hydroxyethoxyl)ethyl ester) (hereinbefore, manufactured by BASF Corp.), Speedcure TPO (manufactured by Lambson Limited), Lucirin TPO, LR8893, and LR8970 (hereinbefore, manufactured by BASF Corp.) and Ubecryl P36 (UCB Chemicals).

Specific examples of other photo-cationic polymerization initiators, which are not particularly limited, include a sulfonium salt, an iodonium salt, and the like.

Specific examples of commercially available products of the photo-cationic polymerization initiator, which are not particularly limited, include Irgacure 250, Irgacure 270, and the like.

The above photopolymerization initiators may be used alone or two or more kinds may be used in combination.

The content of the photopolymerization initiator is preferably equal to or less than 15% by mass, and more preferably equal to or less than 10% by mass with respect to the total amount of the ink composition for ultraviolet ray curable-type ink jet recording. When the content of the photopolymerization initiator is equal to or less than 15% by mass, there is a tendency that storage stability and a cleaning return property are further improved. In addition, the lower limit of the content of the photopolymerization initiator is preferably equal to or greater than 1% by mass, more preferably equal to or greater than 3% by mass, and still more preferably equal to or greater than 5% by mass with respect to the total amount of the ink composition for ultraviolet ray curable-type ink jet recording. In addition, when the content of the photopolymerization initiator is equal to or greater than 1% by mass, curability tends to be further improved. In particular, the photopolymerization initiator preferably includes the acylphosphine oxide-based photopolymerization initiator of the content of the above range from the viewpoint of the above tendency.

### Coloring Material

As a coloring material, which is not particularly limited, the following pigments and dyes are exemplified.

Examples of an inorganic pigment, which are not particularly limited, include carbon blacks such as a furnace black, a lamp black, an acetylene black, and a channel black (C. I. Pigment Black 7), iron oxide, and titanium oxide.

Examples of an organic pigment, which are not particularly limited, include a quinacridone-based pigment, a quinacridonequinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perynone-based pigment, a quinophthalone-based pigment, an anthraquinone-based pigment, a thioindigo-based pigment, a benzimidazolone-based pigment, an isoindolinone-based pigment, an azomethine-based pigment, and an azo-based pigment.

The pigments may be used alone or two or more kinds may be used in combination.

The content of the pigment is preferably 0.5% by mass to 15% by mass, and more preferably 1% by mass to 10% by mass. When the content of a pigment is within the above range, coloring properties tend to be excellent.

As the dye, which is not particularly limited, an acidic dye, a direct dye, a reactive dye, and a basic dye can be used. Examples of the dyes include C. I. Acid Yellow 17, 23, 42, 44, 79, and 142, C. I. Acid Red 52, 80, 82, 249, 254, and 289, C. I. Acid Blue 9, 45, and 249, C. I. Acid Black 1, 2, 24, and 94, C. I. Food Black 1 and 2, C. I. Direct Yellow 1, 12, 24, 33, 50, 55, 58, 86, 132, 142, 144, and 173, C. I. Direct Red 1, 4, 9, 80, 81, 225, and 227, C. I. Direct Blue 1, 2, 15, 71, 86, 87, 98, 165, 199, and 202, C. I. Direct Black 19, 38, 51, 71, 154, 168, 171, and 195, C. I. Reactive Red 14, 32, 55, 79, and 249, and C. I. Reactive Black 3, 4, and 35.

The dyes may be used alone or in combinations of two or more kinds thereof.

The content of the dye is preferably 1% by mass to 20% by mass with respect to 100% by mass of the ink composition since an excellent concealing property and color reproducibility are obtained.

### Other Components

In the ink composition used in the embodiment, various additives such as a dispersant, a surfactant, a penetrating agent, a wetting agent, a solubilizer, a viscosity modifier, a pH adjusting agent, an antioxidant, a preservative, an antifungal agent, a corrosion inhibitor, a polymerization inhibitor (for example, p-methoxyphenol), and a chelating agent for capturing metal ions which affect dispersion can be suitably added in order to maintain an excellent storage stability thereof and an excellent discharge stability from a head, to improve anti-clogging performance, or to prevent deterioration of the ink composition.

### Irradiation Step

The irradiation step is a step of initially irradiating the ink composition attached to a recording medium with ultraviolet rays from the light emitting portion. By irradiating the ink composition attached to a recording medium with ultraviolet rays (light) from a light source, the ink composition is cured. In irradiation step, the photopolymerization initiator included in the ink composition is decomposed by irradiation with ultraviolet rays, due to this, initiating species such as a radical, an acid, and a base are generated, and the polymerization reaction of the polymerizable compound is promoted by functions of the initiating species. Alternatively, in the irradiation step, the polymerization reaction of the polymerizable compound is initiated by irradiation with ultraviolet rays.

### Post-Irradiation Step

The recording method of the embodiment may have a post-irradiation step of irradiating the ink composition gone through the irradiation step with ultraviolet rays one or two or more times which is performed after the irradiation step. As the irradiator used in the post-irradiation step, an irradiator used in the irradiation step may be used, an irradiator other than the irradiator used in the irradiation step may be used, and the latter is preferable from the viewpoint of ease to change to irradiation intensity different from that of the irradiator used in the irradiation step. At least one of the irradiation step and the post-irradiation step may include an irradiation for temporary curing, and in particular, the radiation in the irradiation step is preferably an irradiation for temporary curing. Here, “temporary curing” means temporary tacking (pinning) of an ink composition, and in more detail, means curing before the main curing to prevent bleeding between dots or control a dot diameter. In general, the polymerization degree of a polymerizable compound in the temporary curing is lower than the polymerization degree of the polymerizable compound by the main curing performed after temporary curing. In addition, “main curing” refers to curing the dots formed on a recording medium to a cured state required for use of a recorded product. Here, “curing” in the specification means the above-described main curing unless particularly otherwise described. Plural times of irradiation with ultraviolet rays are preferably performed in one pass (one scan).

The lower limit of the total amount of ultraviolet ray irradiation energy in the irradiation step and the post-irradiation step is preferably equal to or greater than 100 mJ/cm², and more preferably equal to or greater than 200 mJ/cm². In addition, the upper limit of the total amount of ultraviolet ray irradiation energy in the irradiation step and the post-irradiation step is preferably equal to or less than 1500 mJ/cm², more preferably equal to or less than 1400 mJ/cm², still more preferably equal to or less than 1000 mJ/cm², further still more preferably equal to or less than 800 mJ/cm², and most preferably equal to or less than 600 mJ/cm². When the total amount of ultraviolet ray irradiation energy in the irradiation step and the post-irradiation step is within the above range, there is a tendency that tack is suppressed, and internal curability can be further improved.

The ultraviolet ray irradiation energy in the irradiation step is preferably 5 mJ/cm² to 40 mJ/cm², and more preferably 5 mJ/cm² to 30 mJ/cm². When the ultraviolet ray irradiation energy in the irradiation step is within the above range, there is a tendency that a cleaning return property and surface curability become excellent, and bleeding is further suppressed.

Irradiation intensity of a light source having largest irradiation energy in ultraviolet ray irradiation in the post-irradiation step is preferably 350 mW/cm² to 2000 mW/cm², more preferably 500 mW/cm² to 2000 mW/cm², and still more preferably 700 mW/cm² to 1500 mW/cm². When the irradiation intensity of a light source having largest irradiation energy in ultraviolet ray irradiation in the post-irradiation step is within the above range, there is a tendency that tack is suppressed, and internal curability can be further improved.

The ultraviolet ray irradiation energy in the irradiation step is preferably 1/150 to 1/7, and more preferably 1/120 to 1/12 with respect to the total amount of ultraviolet ray irradiation energy in the post-irradiation step. When the ultraviolet ray irradiation energy in the irradiation step is within the above range, there is a tendency that a cleaning return property and surface curability become excellent, and bleeding is further suppressed.

As the light emitting portion used in the post-irradiation step, which is not particularly limited, the same as in the above-described irradiation step can be exemplified.

### Cleaning Step

The cleaning step is a cleaning step for cleaning the nozzle forming surface by a wiping member using a cleaning liquid. When the distance between the ink jet head and the irradiator is made to be short, and a tri- or higher functional polymerizable compound is used, leakage light (including reflected light by a recording medium) from the irradiator is irradiated to the nozzle forming surface, and contamination due to a polymer of the a tri- or higher functional polymerizable compound on the nozzle forming surface is generated, and due to this, a flying bend occurs or nozzles are clogged. If flushing, or discharge of the ink by suction or pressurization is regularly performed in order to remove the contamination, in particular, the ink composition is localized around the nozzle, and due to this, a discharge failure such as a flying bend is caused. Therefore, wiping for removing the ink composition attached around the nozzle is performed.

However, when the ink composition around the nozzle is removed by wiping, there is a case where the ink composition remains attached in a state of being thinly spread over the nozzle forming surface. The ink remained over the nozzle forming surface is cured by leakage light, and the cured ink becomes a foreign matter which cannot be removed by wiping. It is considered that the foreign matter causes a discharge failure by remaining around the nozzle or in the nozzle. Furthermore, since the foreign matter cannot be completely removed by wiping, the foreign matter becomes a foreign matter which is more difficult to be removed by irradiation with leakage light. In particular, a foreign matter of a polyfunctional polymerizable compound is difficult to be removed. Therefore, in the embodiment, by performing wiping also using a cleaning liquid, a foreign matter which causes a discharge failure is dissolved or swelled, and thus, the foreign matter is more reliably removed.

The cleaning method using a cleaning liquid and a wiping member may be a method in which a cleaning liquid is attached to the nozzle forming surface (and the nozzle if necessary, hereinafter the same), and the nozzle forming surface is wiped with a wiping member. Specifically, as the cleaning method, which is not particularly limited, a method in which the nozzle forming surface is wiped with a wiping member to which a cleaning liquid is attached in advance, and a method in which a cleaning liquid is attached to the nozzle forming surface in advance, and the nozzle forming surface is rubbed with a wiping member (to which a cleaning liquid may be attached or not). Among these, from the viewpoint of a cleaning efficiency, the method in which a cleaning liquid is attached to the nozzle forming surface in advance, and the nozzle forming surface is rubbed with a wiping member is preferable. In this case, at least, it is preferable to attach the cleaning liquid to the nozzle forming surface closer to the irradiator than to the nozzle. In addition, in a case where the nozzle forming surface is wiped with a wiping member to which a cleaning liquid is attached in advance, after separately preparing a wiping member and a cleaning liquid, the cleaning liquid may be attached to the wiping member before wiping, or a wiping member to which a cleaning liquid is attached may be prepared. As the method for attaching a cleaning liquid to the nozzle forming surface or the wiping member, a spraying method, a roller method, a dipping method, and the like can be exemplified.

As the wiping member, which is not particularly limited, for example, a member for wiping a cured product derived from an ink composition attached to a discharge port of a nozzle and the nozzle forming surface is preferable, and it may be a member known in the related art. As the cleaning mechanism, which is not particularly limited, for example, a driving mechanism having a pressing member for relatively pressing the wiping member and the nozzle forming surface to each other can be exemplified. In addition, the driving mechanism may be a mechanism which performs a cleaning operation for removing an ink composition attached to the nozzle forming surface by the wiping member by relatively moving at least one of an absorbing member and a head with respect to the other.

The cleaning step may be performed every time after continuous printing, or may be performed after interrupting printing during continuous printing. In addition, as long as the cleaning step of the embodiment is performed, it is not necessary to use a cleaning liquid in all cleaning, and cleaning not using a cleaning liquid may be combined. In addition, from the viewpoint of the cleaning return property, the wiping direction is preferably a direction parallel to the recording medium transporting direction. In addition, it is preferable to wipe the wiping member by reciprocatively moving in the direction parallel to the recording medium transporting direction.

As the structure or material of the wiping member, which is not particularly limited, an elastic material or a liquid absorbing material can be exemplified, and specifically, an elastomer, a fabric, a sponge, pulp, and the like can be exemplified. Among these, a fabric is preferable. A fabric is likely to be bent, and in particular, in a case where nozzle plate cover is provided, the ink attached to the nozzle surface is more easily wiped. In addition, as the fabric, which is not particularly limited, a fabric consisting of cupra, polyester, polyethylene, polypropylene, lyocell, rayon, or the like can be exemplified. In this case, in particular, if the material of the wiping member is a non-woven fabric (polyester) or cupra, fuzz is difficult to be generated, and due to this, an ink is difficult to be sucked from the nozzle, a dot omission is less likely to occur, and therefore, the material is preferable.

### Cleaning Liquid

The cleaning liquid preferable includes an organic solvent usually used in the ink composition. Due to this, foreign matters generated on the nozzle forming surface is easily removed by be swollen or dissolved, and the removed foreign matters or particles of a pigment or the like contained in the ink is more easily absorbed in the wiping member. The composition of the cleaning liquid is preferably a liquid having the above functions, and is not particularly limited.

Examples of the organic solvent, which are not particularly limited, include an alkylene glycol derivative, an alcohol-based solvent, an alkylene glycol-based solvent, and a hydrocarbon-based solvent. Among these, an alkylene glycol derivative, an alkylene glycol-based solvent, and an alcohol-based solvent are preferable, and an alkylene glycol derivative is more preferable.

Examples of the alkylene glycol derivative, which are not particularly limited, include alkylene glycol, alkyl ethers of alkylene glycol, esters of alkylene glycol, and ether esters of alkylene glycol. As the alkylene glycol, which is not particularly limited, for example, alkylene glycols obtained by polymerization in a repetition number of an ethylene glycol unit and a propylene glycol unit of 1 to 4 are preferable. As the alkyl ethers of alkylene glycol, which are not particularly limited, for example, alkyl ethers having 1 to 4 carbon atoms are preferable. As the esters of alkylene glycol, which are not particularly limited, for example, acetate, propionate, and butyrate are preferable, and acetate is more preferable.

The content of the organic solvent is preferably equal to or greater than 20% by mass, and more preferably equal to or greater than 50% by mass, and still more preferably equal to or greater than 70% by mass with respect to 100% by mass of the cleaning liquid. The upper limit of the content of the organic solvent is not particularly limited. In addition, the cleaning liquid may suitably include a polymerization inhibitor, a surfactant, or the like other than the above.

### Recording Medium

As the recording medium, an absorbing recording medium or a non-absorbing recording medium can be exemplified. The ink jet recording method can be widely applied to a recording medium having various absorption performances from the non-absorbing recording medium into which a water soluble ink composition is less likely to penetrate to the absorbing recording medium into which an ink composition is likely to penetrate. Here, in a case where the ink composition is applied to the non-absorbing recording medium, there is a case where it is necessary to provide a drying step after ultraviolet rays are irradiated to cure.

Examples of the absorbing recording medium, which are not particularly limited, include plain paper such as electrophotographic paper in which penetrability of the ink is high, ink jet printing paper (paper used exclusively for an ink jet equipped with an ink absorbing layer composed of silica particles or alumina particles, or an ink absorbing layer composed of a hydrophilic polymer such as polyvinyl alcohol (PVA) or polyvinyl pyrrolidone (PVP)), art paper, coated paper, and cast paper used in general offset printing in which penetrability of the ink is relatively low.

Examples of the non-absorbing recording medium, which are not particularly limited, include films or plates of plastics such as polyvinyl chloride, polyethylene, polypropylene, and polyethylene terephthalate (PET), plates of metals such as iron, silver, copper, and aluminum, metal plates or films made of plastic produced by deposition of these various metals, plates of alloy of stainless or brass, and the like.

### EXAMPLES

Hereinafter, the invention will be more specifically described using Examples and Comparative Examples. The invention is not limited to these Examples.

### Material for Ink Composition

The main material for the ink composition used in the following Examples and Comparative Examples are as follows.

### Coloring Material

### Carbon Black

### Mono- or Bifunctional Polymerizable Compound

VEEA (2-(2-vinyloxyethoxyl)ethyl acrylate, manufactured by Nippon Shokubai Co., Ltd., the number of functional group of 1)
PEA (phenoxyethyl acrylate, manufactured by Osaka Organic Chemical Industry Ltd., the number of functional group of 1)
DPGDA (dipropylene glycol diacrylate, manufactured by Sartomer Co., Ltd., the number of functional group of 2) Tri- or Higher Functional Polymerizable Compound A-DPH (dipentaerythritol hexaacrylate, manufactured by Shin-Nakamura Chemical Co., Ltd., the number of functional group of 6)
SR444 (pentaerythritol triacrylate, manufactured by Nippon Kayaku Co., Ltd., the number of functional group of 3)

### Photopolymerization Initiator

Irgacure 819 (trade name, manufactured by BASF Corp., 100% by mass of solid content)
Darocuer TPO (trade name, manufactured by BASF Corp., 100% by mass of solid content)

### Dispersant

Solsperse 36000 (manufactured by Lubrizol Corp.)

### Preparation of Ink Composition

Each material was mixed according to the composition (% by mass) shown in Table 1, and sufficiently stirred, whereby each ink composition was obtained.

TABLE 1

| | | Ink composition No | | | | | | | | | |
|---|---|---|---|---|---|---|---|---|---|---|---|
| | | 1 | 2 | 3 | 4 | 5 | 6 | 7 | 8 | 9 | 10 |
| Coloring material | Carbon black | 3.0 | 3.0 | 3.0 | 3.0 | 3.0 | 3.0 | 3.0 | 3.0 | 3.0 | 3.0 |
| Mono- or bifunctional polymerizable compound | VEEA | 20.0 | 30.0 | 30.0 | 40.0 | 7.0 | 30.0 | 25.0 | 30.0 | 28.0 | 24.0 |
| | PEA | 40.0 | 20.0 | 20.0 | 30.0 | 40.0 | 25.0 | 22.0 | 28.0 | 40.0 | 14.0 |
| | DPGDA | 20.0 | 30.0 | 30.0 | 10.0 | 35.0 | 30.0 | 26.0 | 30.0 | | 30.0 |
| Tri- or higher functional polymerizable compound | A-DPH | 8.0 | 8.0 | 4.0 | | 2.0 | 8.0 | 15.0 | | 20.0 | |
| | SR444 | | | 4.0 | 8.0 | 4.0 | | | | | 20.0 |
| Polymerization initiator | Irgacure 819 | 3.0 | 3.0 | 3.0 | 3.0 | 3.0 | 2.0 | 3.0 | 3.0 | 3.0 | 3.0 |
| | Darocur TPO | 5.0 | 50. | 5.0 | 5.0 | 5.0 | 1.0 | 5.0 | 5.0 | 5.0 | 5.0 |
| Dispersant | Solsperse 36000 | 1.0 | 1.0 | 1.0 | 1.0 | 1.0 | 1.0 | 1.0 | 1.0 | 1.0 | 1.0 |

| | | | | | | | | | | |
|---|---|---|---|---|---|---|---|---|---|---|
| Total | 100.0 | 100.0 | 100.0 | 100.0 | 100.0 | 100.0 | #### | 100.0 | 100.0 | 100.0 |
| Curability | A | A | A | A | B | B | A | B | A | A |
| Storage stability | A | A | A | A | A | A | B | A | B | B |
| Viscosity (20° C.) | A | A | A | A | A | A | A | A | B | B |

### Ink Jet Recording Method

### Examples 1 to 11 and Comparative Examples 1 to 10

A SurePress L-4033A (manufactured by Seiko Epson Corporation) remodeled as follows was used. As shown in FIG. 2, four line heads (heads having a length substantially corresponding to a width (recording width) in which an image was recorded, on a recording medium) were configured along the transport direction of a recording medium, and a light source was disposed in the transport direction downstream of each head. Moreover, in recording by the line printer, among the heads and the light sources shown in FIG. 2, the head K, the temporary curing irradiation portion 42a, and the main curing irradiation portion 44 were used, and the other things were not used. In addition, the transport drum 26 was made of aluminum, the diameter of the transport drum 26 was 500 mm, the printing speed was 285 mm/sec, and the drum rotation period was 5.5 seconds. As the head, a head having a nozzle density in the recording medium width direction of the nozzle array of 600 dpi was used. Moreover, the distance between the nozzle forming surface and the recording medium was 1 mm. In addition, the distance from the end portion of the nozzle forming surface closest to the light emitting portion to a nozzle closest to the end portion was 1 cm.

Each of the ink compositions shown in Table 1 was discharged towards a PET film (Lumirror S10 (thickness of 100 μm) manufactured by Toray Industries, Inc.) from the head K under the conditions of the recording resolution of 600 dpi×600 dpi and one pass (single pass). At this time, the amount of ink droplet per pixel was adjusted such that the film thickness after curing becomes 10 μm. In this manner, a beta pattern image was formed. Moreover, the term “solid pattern image” means an image in which the entire area of the recording medium are covered by an ink in pattern in which dots are recorded with respect to an entire pixel of a pixel which is a minimum recording unit area defined by a recording resolution.

Subsequently, the ink attached to a PET film was irradiated with ultraviolet rays from the light source to cure the ink composition under the conditions shown in Table 2. Specifically, first, as the light source 42a, LED having a peak wavelength of 395 nm and an irradiation peak intensity of 50 mW/cm² was used. A temporary curing was performed by irradiation with ultraviolet rays with irradiation energy of 15 (mJ/cm²) from the LED. In addition, as the light source 44, LED having a peak wavelength of 395 nm and an irradiation peak intensity of 1500 mW/cm² was used. A solid pattern image was cured (main curing) by irradiation with ultraviolet rays with irradiation energy (mJ/cm²) shown in Table 2 for a predetermined period of time from the LED. In this manner, a cured film formed by curing the above solid pattern image was obtained. Moreover, it was confirmed that there was no tackiness feeling of the cured film surface by a finger touch test. Moreover, the above-described temporary curing corresponds to the irradiation step, the main curing corresponds to the post-irradiation step, and the irradiation energy of the main curing corresponds to the total irradiation energy of the post-irradiation step. The illuminance (irradiation intensity) was measured using an ultraviolet ray intensity meter UM-10 and a light-receiving unit UM-400 (manufactured by Konica Minolta Sensing, Inc.), the irradiation energy was determined from the product of the illuminance and the duration of irradiation (seconds).

After continuous printing for 60 minutes, any one of the following cleanings 1 to 4 was performed. Specific contents of the cleaning are shown below.

Cleaning 1: After 10 cc of the ink was discharged from the nozzle by applying pressure, 10 cc (per head, nozzle number of 1 head was 360) of ethyl diglycol acetate as the cleaning liquid was uniformly ejected to the end portion close to the irradiation portion of the nozzle forming surface and attached. Then, the nozzle plate was reciprocatively wiped 30 times in the direction (the wiping direction is the direction parallel to the recording medium transporting direction) intersecting the nozzle array using a rubber wiper as the wiping member.
Cleaning 2: The same operations as Cleaning 1 were performed except that the cleaning liquid was not used.
Cleaning 3: Although 10 cc of the ink was discharged from the nozzle by applying pressure, ejection of the cleaning liquid and wiping were not performed.
Cleaning 4: The same operations as Cleaning 1 were performed except that triethylene glycol monobutyl ether was used as the cleaning liquid.

Moreover, the wiping member was formed of a fluorine rubber in a blade shape, the thickness was 0.8 mm, the height was 1.5 cm, the length was equal to the length of the nozzle forming surface in the direction of the nozzle array, and the wiping member was configured so as to be able to wipe the entire nozzle forming surface by one wiping.

### Storage Stability

Each of the ink compositions was put into a sample bottle, then the sample bottle was left to stand at 60° C. for seven days, and the viscosity (25° C.) after being left to stand was measured using a Digital viscometer VM-100 manufactured by Yamaichi Electronics Co., Ltd. Storage stability was evaluated by the degree of change of the viscosity (viscosity change) after being left to stand with respect to the viscosity before being left to stand. The evaluation criteria are shown below.

A: Viscosity change was less than 5%.
B: Viscosity change was equal to or greater than 5% and less than 10%.
C: Viscosity change was equal to or greater than 10% and less than 15%.
D: Viscosity change was equal to or greater than 15%.

### Bleeding

Instead of a solid pattern, a pattern of alphabetical letters from A to Z was recorded in the same manner as described above. In the letter pattern, letters having a size of 2 points to 5 points were recorded. Bleeding was evaluated based on the points of visually recognizable letters.

A: All of letters of 2 points to 5 points could be visually confirmed.
B: All of letters of 3 points to 5 points could be visually confirmed.
C: All of letters of 4 points to 5 points could be visually confirmed.
D: All of letters of 5 points could be visually confirmed.

### Streak Unevenness

On the basis of the observation result of the cured film obtained in the above-described manner, streak unevenness was evaluated according to the following evaluation criteria.

A: Even when observed through a magnifying glass, there was no streak unevenness (which is a streak extending in the transport direction of the recording medium, and is in the state where the base can be seen since the recording medium was not fully covered with an ink).
B: When observed through a magnifying glass, the occurrence of streak unevenness was observed.

### Wrinkles

On the basis of the cured film obtained in the above-described manner and the measurement result of the glossiness of a coating film at 60° according to JIS 28741, curing wrinkles were evaluated according to the following evaluation criteria. By comparing the glossiness, it was possible to indirectly check the degree of generation of curing wrinkles, and it means that as the glossiness is smaller, the curing wrinkles are more likely to occur.

A: Glossiness was equal to or greater than 90% compared to Example 1.
B: Glossiness was equal to or greater than 80% and less than 90% compared to Example 1.
C: Glossiness was equal to or greater than 20% and less than 80% compared to Example 1.
D: Glossiness was equal to or less than 20% compared to Example 1.

### Cleaning Return Property

After continuous printing for 10 minutes, 30 minutes, and 60 minutes, respectively, the ink was discharged in the amount of 10 cc/360 nozzles from the ink jet nozzles by applying pressure. Then, the cleanings described in Table 1 were performed. A discharge test of the ink jet nozzles after cleaning was performed, and an occurrence of a discharge failure of the nozzles was examined. A case where a discharge failure (non-discharge or flying bend) of one or more among 360 nozzles occurs was evaluated as “there is no cleaning return property”, and a case where a discharge failure does not occur in all of 360 nozzles was evaluated as “there is cleaning return property”.

A: After continuous printing for 60 minutes, a cleaning return property was observed.
B: After continuous printing for 30 minutes, a cleaning return property was observed, however, after continuous printing for 60 minutes, a cleaning return property was not observed.
C: After continuous printing for 10 minutes, a cleaning return property was observed, however, after continuous printing for 30 minutes, a cleaning return property was not observed.
D: After continuous printing for 10 minutes, a cleaning return property was not observed.

TABLE 2

| | Example | | | | | | | | | | |
|---|---|---|---|---|---|---|---|---|---|---|---|
| | 1 | 2 | 3 | 4 | 5 | 6 | 7 | 8 | 9 | 10 | 11 |
| Ink composition | 1 | 2 | 3 | 4 | 5 | 1 | 1 | 6 | 1 | 7 | 1 |
| The distance between the end portion of the nozzle | 40 | 40 | 40 | 40 | 40 | 40 | 40 | 40 | 40 | 40 | 10 |
| forming surface closest to the light emitting portion and | | | | | | | | | | | |
| the end portion of the light emitting portion closest to the | | | | | | | | | | | |
| nozzle forming surface (mm) | | | | | | | | | | | |
| Temporary curing irradiation energy/ | 1/20 | 1/20 | 1/20 | 1/20 | 1/20 | 1/140 | 1/10 | 1/10 | 1/20 | 1/20 | 1/20 |
| main curing irradiation energy | | | | | | | | | | | |
| Main curing irradiation energy mJ/cm² | 300 | 300 | 300 | 300 | 450 | 300 | 300 | 450 | 300 | 300 | 300 |
| Cleaning step | 1 | 1 | 1 | 1 | 1 | 1 | 1 | 1 | 4 | 1 | 1 |
| Bleeding | A | A | A | A | A | B | A | B | A | A | A |
| Streak unevenness | A | A | A | A | A | A | B | A | A | A | B |
| Wrinkles | A | A | A | B | A | A | A | A | A | A | A |
| Cleaning return property | A | A | A | A | A | A | B | A | A | B | B |

| | Comparative Example | | | | | | | | | |
|---|---|---|---|---|---|---|---|---|---|---|
| | 1 | 2 | 3 | 4 | 5 | 6 | 7 | 8 | 9 | 10 |
| Ink composition | 8 | 1 | 1 | 1 | 8 | 9 | 10 | 1 | 1 | 8 |
| The distance between the end portion of the nozzle | 40 | 70 | 70 | 70 | 70 | 40 | 10 | 40 | 40 | 40 |
| forming surface closest to the light emitting portion and | | | | | | | | | | |
| the end portion of the light emitting portion closest to the | | | | | | | | | | |
| nozzle forming surface (mm) | | | | | | | | | | |
| Temporary curing irradiation energy/ | 1/20 | 1/140 | 1/10 | 1/20 | 1/20 | 1/20 | 1/20 | 1/20 | 1/20 | 1/20 |
| main curing irradiation energy | | | | | | | | | | |
| Main curing irradiation energy | 450 | 300 | 300 | 300 | 300 | 300 | 300 | 300 | 300 | 450 |
| mJ/cm² | | | | | | | | | | |
| Cleaning step | 1 | 1 | 1 | 1 | 1 | 1 | 1 | 2 | 3 | 2 |
| Bleeding | A | C | C | C | C | A | A | A | A | A |
| Streak unevenness | A | A | B | A | A | A | B | A | A | A |
| Wrinkles | C | A | A | A | A | A | A | A | A | C |
| Cleaning return property | A | A | B | A | B | C | C | C | D | B |

It was found that in Comparative Example 1 using an ink composition not including a tri- or higher functional polymerizable compound, wrinkles occurred. In addition, it was found that among Comparative Examples 2 to 5 in which the distance between the end portion of the nozzle forming surface closest to the light emitting portion and the end portion of the light emitting portion closest to the nozzle forming surface was 70 mm, in Comparative Examples 2, 4, and 5, bleeding occurred, and in Comparative Example 3 in which a proportion of temporary curing energy was high, streak unevenness occurred. Furthermore, it was found that in Comparative Examples 6 and 7 using an ink composition including equal to or greater than 20% by mass of a tri- or higher functional polymerizable compound, a cleaning return property was poor. In addition, it was found that among Comparative Examples 8 to 10 in which a cleaning liquid was not used in the cleaning step, in Comparative Examples 8 and 9, a cleaning return property was poor, and in Comparative Example 10 using an ink composition not including a tri- or higher functional polymerizable compound, wrinkles occurred. Moreover, in all examples, instead of printing by discharging an ink to an ink receiver from the head without emitting ultraviolet rays from the light emitting portion in a state where the power of the light source is turned OFF, when the cleaning return property test was performed after continuous discharging operations were performed in the same manner, all of the examples in which the results of the cleaning return property test in Table were A, B, and C become A, however, the example in which the result was D remained D. In the examples in which the result was at least B or C in a cleaning return property test, it is considered that ultraviolet rays contribute to generation of foreign matters on the nozzle forming surface.

The entire disclosure of Japanese Patent Application No.: 2014-015226, filed Jan. 30, 2014 is expressly incorporated by reference herein.

What is claimed is:

1. An ink jet recording method for recording using a recording apparatus equipped with an ink jet head having a nozzle forming surface on which a nozzle is formed and an irradiator having a light emitting portion for initially irradiating an ink composition attached to a recording medium by discharging from the head with ultraviolet rays, in which a closest distance between an end portion of the nozzle forming surface and an end portion of the light emitting portion is equal to or less than 60 mm, the method comprising:
attaching to a recording medium by discharging an ink composition for ultraviolet ray curable-type ink jet recording including a tri- or higher functional polymerizable compound of equal to or less than 15% by mass and a photopolymerization initiator from the nozzle;
irradiating the ink composition for ultraviolet ray curable-type ink jet recording attached to the recording medium with ultraviolet rays from the light emitting portion;
and cleaning the nozzle forming surface with a cleaning liquid and a wiping member.

2. The ink jet recording method according to claim 1,
wherein the ink jet head has a nozzle array width of a length equal to or greater than a recording width of the recording medium, the attaching is performed by a single scan of the ink jet head relative to the recording medium.

3. The ink jet recording method according to claim 1,
wherein the cleaning liquid includes an alkylene glycol derivative.

4. The ink jet recording method according to claim 1,
wherein the ink composition for ultraviolet ray curable-type ink jet recording includes a mono- or bifunctional polymerizable compound of 50% by mass to 90% by mass.

5. The ink jet recording method according to claim 1,
wherein the irradiator is equipped with a light source, and the light source is a semiconductor light source having a peak wavelength in a wavelength range of 350 nm to 420 nm.

6. The ink jet recording method according to claim 1,
wherein the photopolymerization Initiator includes an acylphosphine oxide-based photopolymerization initiator of 5% by mass to 15% by mass with respect to the total amount of the ink composition for ultraviolet ray curable-type ink jet recording.

7. The ink jet recording method according to claim 1, further comprising:
a post-irradiation of irradiating the ink composition for ultraviolet ray curable-type ink jet recording gone through the irradiation with ultraviolet rays one or two or more times which is performed after the irradiation.

8. The ink jet recording method according to claim 7,
wherein ultraviolet ray irradiation energy in the irradiation is a 1/150 to 1/7 of the total amount of ultraviolet ray irradiation energy in the post-irradiation.

9. The ink jet recording method according to claim 7,
wherein the total amount of ultraviolet ray irradiation energy in the irradiation and the post-irradiation is 100 mJ/cm² to 1500 mJ/cm², and ultraviolet ray irradiation energy in the irradiation is 5 mJ/cm² to 40 mJ/cm².

10. A recording apparatus,
wherein the ink jet recording method according to claim 1 is performed.

11. A recording apparatus,
wherein the ink jet recording method according to claim 2 is performed.

12. A recording apparatus,
wherein the ink jet recording method according to claim 3 is performed.

13. A recording apparatus,
wherein the ink jet recording method according to claim 4 is performed.

14. A recording apparatus,
wherein the ink jet recording method according to claim 5 is performed.

15. A recording apparatus,
wherein the ink jet recording method according to claim 6 is performed.

16. A recording apparatus,
wherein the ink jet recording method according to claim 7 is performed.

17. A recording apparatus,
wherein the ink jet recording method according to claim 8 is performed.

18. A recording apparatus,
wherein the ink jet recording method according to claim 9 is performed.
